(19) United States
(12) Patent Application Publication
(10) Pub. No.: US 2017/0078848 A1
(43) Pub. Date: Mar. 16, 2017

(54) Method and Apparatus for Selectively Providing Real-Time Status for Portable Devices

(71) Applicants: Ahmad Saqer Almarri, Dubai (AE); Mohammed Gheyath, Dubai (AE)

(72) Inventors: Ahmad Saqer Almarri, Dubai (AE); Mohammed Gheyath, Dubai (AE)

(21) Appl. No.: 14/850,818

(22) Filed: Sep. 10, 2015

(51) Int. Cl. H04W 4/02; H04W 8/22

(52) U.S. Cl. CPC H04W 4/025; H04W 8/22

(57) ABSTRACT

One aspect of the present invention discloses a network device containing my-status application capable of handling real-time user status using a portable electronic device (“PED”). A process of PED is able to collect a geographic location associated with the PED from an onboard location module. After obtaining scheduled information associated with the PED from a calendar module, current status associated with the user of the PED is generated in accordance with the geographic location and the scheduled information. After filtering current status according to a predefined set of contact list, the filtered current status is forwarded to a selected group of audience via the communications network based on a predefined set of contact list.

### FIELD

The exemplary embodiment(s) of the present invention relates to telecommunications network. More specifically, the exemplary embodiment(s) of the present invention relates to wireless communications network.

### BACKGROUND

A typical high-speed communication network, which is able to deliver massive amount of information and/or data between sources and destinations, may contain multiple networks for information to reach its destination. The communication network, for example, includes wired and wireless communications networks. The networks, for instance, may include, but not limited to, wired network, backbone network, wireless network, cellular network, wireless personal area network (“WPAN”), wireless local area network (“WLAN”), wireless metropolitan area network (“MAN”), or a combination of wired, backbone, wireless, cellular, WPAN, WLAN, MAN, WIFI, or the like.

With rapidly growing trend of mobile end-to-end (“ETE”) communications between users, timely facilitating communications become part of modern society. However, a problem associated with a conventional wireless communications network is that traditional network technology does not show current status of recipients as to whether the recipients are willing and able to communicate with the sender(s). For example, when a caller tries to call a recipient using a cellular phone, the caller typically does not know current activity(s) or status associated with the recipient.

### SUMMARY

The following summary illustrates a simplified version(s) of one or more aspects of present invention. The purpose of this summary is to present some concepts in a simplified description as more detailed description that will be presented later.

One aspect of the present invention discloses a portable electronic device (“PED”) such as a cellular phone that contains a digital processing unit, memory, transmitter, and receiver capable of providing information via a communications network is capable of handling real-time user status using user's PED. A process of PED is able to collect a geographic location associated with the PED from an onboard location module indicating current location of the PED. After obtaining scheduled information associated with the PED via a calendar module, current status associated with the user of the PED is generated in accordance with the geographic location and the scheduled information. After filtering my status according to a predefined set of contact list, the filtered current status is forwarded to a selected group of audience via the communications network based on the predefined set of contact list.

Additional features and benefits of the exemplary embodiment(s) of the present invention will become apparent from the detailed description, figures and claims set forth below.

### BRIEF DESCRIPTION OF THE DRAWINGS

The exemplary aspect(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating a computing network configured to provide network communication using my-status in accordance with one embodiment of the present invention;

FIG. 2 is a block diagram illustrating a logic flow of providing my-status in a communications network in accordance with one embodiment of the present invention;

FIG. 3 is a block diagrams illustrating a my-status logic flow capable of generating and broadcasting current status in accordance with one embodiment of the present invention;

FIG. 4 illustrates exemplary images displayable by a portable electronic device (“PED”) showing current status in accordance with one embodiment of the present invention;

FIG. 5 is a block diagram illustrating an exemplary system capable of providing my-status operation in accordance with one embodiment of the present invention;

FIG. 6 is a flowchart illustrating a process of receiving an incoming call using my-status in accordance with one embodiment of the present invention; and

FIG. 7 is a flowchart illustrating a process of providing current status using my-status in accordance with one embodiment of the present invention.

### DETAILED DESCRIPTION

Embodiments of the present invention are described herein in the context of methods and/or apparatus for providing current status associated with mobile users using my-status application.

The purpose of the following detailed description is to provide an understanding of one or more embodiments of the present invention. Those of ordinary skills in the art will realize that the following detailed description is illustrative only and is not intended to be in any way limiting. Other embodiments will readily suggest themselves to such skilled persons having the benefit of this disclosure and/or description.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. Moreover, it will be understood that such a development effort might be complex and time-consuming, but would nevertheless be a routine undertaking of engineering for those of ordinary skills in the art having the benefit of embodiment(s) of this disclosure.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method. The same reference indicators will be used throughout the drawings and the following detailed description to refer to the same or like parts.

The term “system” or “device” is used generically herein to describe any number of components, elements, sub-systems, devices, packet switch elements, packet switches, access switches, routers, networks, modems, base stations, eNB (eNodeB), computer and/or communication devices or mechanisms, or combinations of components thereof. The term “computer” includes a processor, memory, and buses capable of executing instruction wherein the computer refers to one or a cluster of computers, personal computers, workstations, mainframes, or combinations of computers thereof.

IP communication network, IP network, or communication network means any type of network having an access network that is able to transmit data in a form of packets or cells, such as ATM (Asynchronous Transfer Mode) type, on a transport medium, for example, the TCP/IP or UDP/IP type. ATM cells are the result of decomposition (or segmentation) of packets of data, IP type, and those packets (here IP packets) comprise an IP header, a header specific to the transport medium (for example UDP or TCP) and payload data. The IP network may also include a satellite network, a DVB-RCS (Digital Video Broadcasting-Return Channel System) network, providing Internet access via satellite, or an SDMB (Satellite Digital Multimedia Broadcast) network, a terrestrial network, a cable (xDSL) network or a mobile or cellular network (GPRS/EDGE, or UMTS (where applicable of the MBMS (Multimedia Broadcast/Multicast Services) type, or the evolution of the UMTS known as LTE (Long Term Evolution), or DVB-H (Digital Video Broadcasting-Handhelds)), or a hybrid (satellite and terrestrial) network.

One embodiment of the present invention discloses a network device containing a digital processing unit, memory, transmitter, and receiver capable of providing my-status application or my-status via a communications network. In one example, my-status is able to handle real-time status for users using portable electronic devices (“PEDs”). The terms “my-status”, “my-status application”, and “my-status module” are referred to the same apparatus and can be used interchangeably. In one aspect, the process of my-status is able to collect a geographic location associated with a PED from an onboard location module indicating current location of the PED. After obtaining scheduled information associated with the PED from a calendar module, my-status which indicates current status associated with the user of the PED generates current status in accordance with the geographic location and the scheduled information. After filtering current status according to a predefined set of contact list, the list of filtered current status is produced and subsequently is forwarded or broadcasted via the communications network. The audience of the broadcast, in one example, is based on the predefined set of contact list.

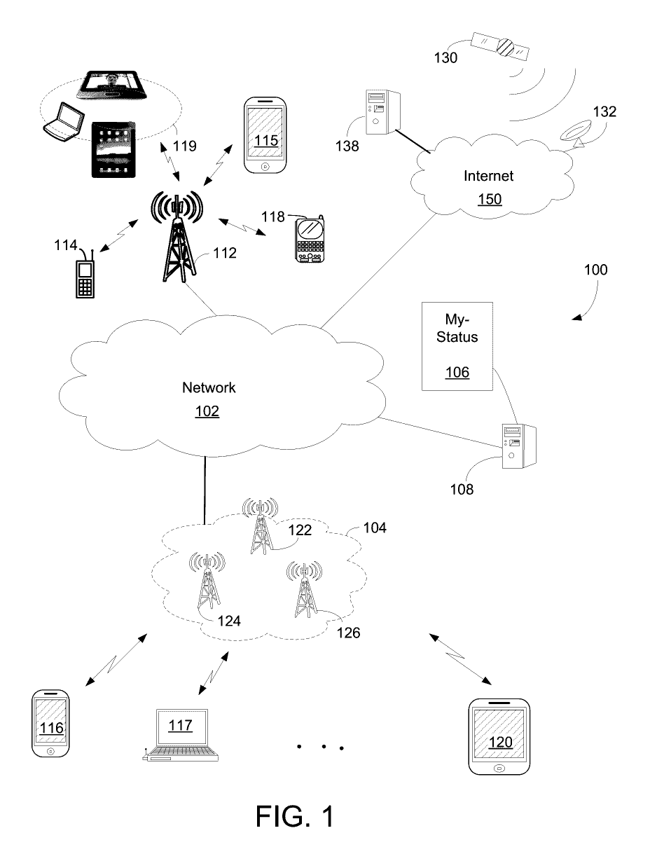

FIG. 1 is a block diagram 100 illustrating a computing network configured to provide network communication using my-status in accordance with one embodiment of the present invention. Diagram 100 illustrates my-status 106, communication network 102, switching network 104, Internet 150, and portable electric devices 114-120. In one aspect, network 102 can be wide area network (“WAN”), metropolitan area network (“MAN”), local area network (“LAN”), satellite/terrestrial network, or a combination of WAN, MAN, and LAN. It should be noted that the underlying concept of the exemplary embodiment(s) of the present invention would not change if one or more blocks (or networks) were added to or removed from diagram 100.

Network 102 includes multiple network nodes, not shown in FIG. 1, wherein each node may include mobility management entity (“MME”), radio network controller (“RNC”), serving gateway (“S-GW”), packet data network gateway (“P-GW”), or HomeAgent to provide various network functions. Network 102 is coupled to Internet 150, my-status server 108, base station 112, and switching network 104. Server 108, in one embodiment, includes my-status management or my-status 106 which can be software, hardware, or combination of software and hardware component.

Switching network 104, which can be referred to as packet core network, includes cell sites 122-126 capable of providing radio access communication, such as 3G (3^{rd} generation), 4G, or 5G cellular networks. Switching network 104, in one example, includes IP and/or Multi Protocol Label Switching (“MPLS”) based network capable of operating at a layer of Open Systems Interconnection Basic Reference Model (“OSI model”) for information transfer between clients and network servers. In one embodiment, switching network 104 is logically coupling multiple PEDs 114-120 across a geographic area via cellular networks. It should be noted that the geographic area may refer to a campus, city, metropolitan area, country, continent, or the like.

Base station 112, also known as cell site, node B, or eNodeB, includes a radio tower capable of coupling to various user equipments (“UEs”), PEDs, or electrical user equipments (“EUEs”). The term UEs, PEDs, and EUEs are referring to the similar portable devices and they can be used interchangeably. For example, UEs or PEDs can be cellular phone 114, handheld device 118, iPhone® 116, tablets and/or iPad® 120 via wireless communications. Handheld device 118 can be a smart phone, such as iPhone®, BlackBerry®, Android®, and so on. Base station 112, in one example, facilitates network communication between mobile devices such as portable handheld device 114-120 via wired and wireless communications networks. It should be noted that base station 112 may include additional radio towers as well as other land switching circuitry.

Internet 150 is a computing network using Transmission Control Protocol/Internet Protocol (“TCP/IP”) to provide linkage between geographically separated devices for communication. Internet 150, in one example, couples to supplier server 138 and satellite network 130 via satellite receiver 132. Satellite network 130, in one example, can provide many functions as wireless communication as well as global positioning system (“GPS”). For example, my-status 106 can receive GPS information from satellite network 130 via Internet 150, network 102, and switching network 104.

My-status 106, in one embodiment, is a process of broadcasting current status to a selected group of users in real-time. A function of my-status 106 is able to automatically report user's current status via user's PED. PED can be user's smart phone, notebooks, iPad®, labtop, and/or PC via wireless connection. In one aspect, my-status 106 can be downloaded from server 108 to various PEDs 114-120 based on users' desire. To implement my-status 106, various software and/or hardware may be installed in various locations such as network 102 and base stations 122-126.

During an exemplary operation, a user of iPhone® 116 downloads my-status application (“app”) for my-status 106 from server 108 via networks 102-104. Upon installation of the app, iPhone® 116, in one embodiment, activates a location module, calendar module, and sensor module. While location module, in one example, provides GPS location of iPhone® 116, calendar module obtains information relating to prior scheduled events. After detecting information relating to the movement of iPhone® 116 by a sensor module, current status is derived based on the information relating to location, scheduling information, and movements of iPhone® 116. The current information is subsequently broadcasted to a selected group of audience such as iPhone® 115 and BlackBerry® 118.

An advantage of employing my-status is to provide recipient current status to potential callers or senders whereby the callers and/or senders can decide whether to make the call or not. For example, if the recipient current status indicates a sleeping icon, the caller may decide not to call.

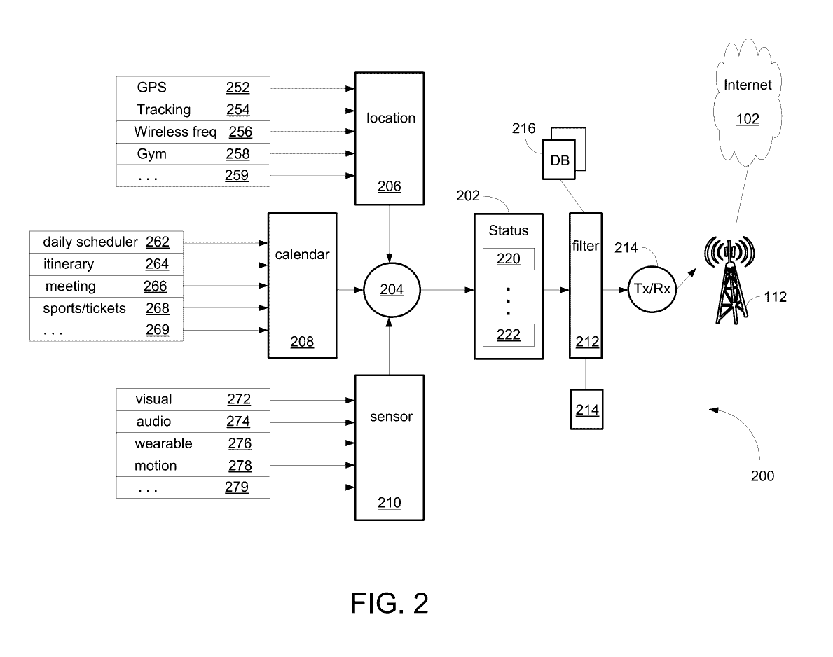

FIG. 2 is a block diagram 200 illustrating a logic flow of providing my-status in a communications network in accordance with one embodiment of the present invention. Diagram 200 includes status component 202, collector 204, location 206, calendar 208, sensor 210, filter 212, and base station 112. In one aspect, my-status further includes a transceiver (or transmitter and receiver) (“Tx/Rx”) 214 which is used to transmit and receive information to and from Internet 102 via base station 112. It should be noted that the underlying concept of the exemplary embodiment(s) of the present invention would not change if one or more blocks (or networks) were added to or removed from diagram 200.

Location 206, which can be a software module, hardware component, or a combination of software and hardware component, includes GPS element 252, tracking element 254, wireless frequency element 256, and gym element 258. GPS element or GPS 252 is a component capable of communicating with GPS to identify current location of PED. Tracking element or tracking 254 includes location measuring devices such as accelerometers for tracking PED's location from the last known location. Accelerometer, in one example, is a three dimensional (“3D”) accelerometer capable of measuring acceleration or movement along x, y, and z coordinates or axis. Accelerometer includes an x-axis accelerometer, a y-axis accelerometer, and/or a z-axis accelerometer and is capable of detecting a 3D physical movement relating to PED. The accelerometers provides measurements relating to relative positions and motions in space along x, y, and z axis of PED.

Wireless frequency element or wireless freq. 256, in one embodiment, is able to detect surrounding wireless frequency(s) to identify possible wireless host(s). Wireless hosts or Wi-Fi hosts provide IP addresses which may indicate owners of the hosts. For example, if the detected IP address indicates Starbucks® coffee shop, it indicates that PED is near or in Starbucks® shop. In one aspect, information obtained by wireless frequency element 256 can be useful to establish and verify the current PED location.

Gym element or gym 258, in one embodiment, detects wireless broadcasting from an entity that identifies itself. For example, a gym provides wireless connection if one is a guest of gym. Similar to wireless frequency element 256, gym element 258 can be useful to establish and verify the current location of PED. Note that other elements such as element 259 may be included in location 206 to assist locating PED location. For example, manual input by the user may be used to identify the location of PED. It should be noted that location 206 and its sub-components GPS 252, tracking 254, wireless freq. 256, and gym 258 are onboard of PED. Providing GPS location can assist my-status or the app to make more accurate status update regarding the user. For instance, the GPS information can indicate the user is at work, home, gym, park, cinema, praying, and the like.

Calendar 208, which can be a software module, hardware component, and/or a combination of software and hardware component, includes a daily scheduler 262, itinerary 264, meeting element 266, and ticket element 268. Daily scheduler 262 is a component capable of tracking daily routines associated with the user. For example, if the user swims every morning between 7 AM and 8 AM, the PED can broadcast busy indicator or swimming icon between 7 AM and 8 AM every day.

Itinerary 264, in one embodiment, is able to record prior or planned itineraries saved in the PED. For example, if the user purchased an airline ticket from New York to London, the PED can broadcast in-flight message (or symbol or icon) to a selected group of audience during the scheduled time for flight between New York and London. It should be noted that the selected group of audience is a group of mobile phone users selected by the user.

Meeting element or meeting 266, in one embodiment, detects meeting events or scheduled activities recorded on PED or other remotely connected devices such as a laptop via some standard meeting schedulers. For example, my-status is able to obtain meeting schedules from Outlook® software operating at a remotely connected device. Obtaining meeting related information can assist the app or my-status to setup more intuitive ring tones to accommodate meeting events. For example, based on the information obtained by calendar 208, a silent or emergency ring tone may be setup to handle other notices, family calls, private calls, and the like.

Sports and tickets module or sports/tickets 268 is able to obtain user past behavior in connection to certain sporting events or concerts or plays. For example, the user of PED, in the past, watches soccer games in the winter and tennis in the summer. To identify user's current status, my-status uses calendar 208 to obtain information relating to daily routines, itineraries, scheduled events, and historical behaviors to determine and verify likelihood current status associated with the user. Note that other elements such as element 269 may be included in calendar 208. Calendar 208 and its sub-components daily scheduler 262, itinerary 264, meeting 266, and sports/tickets elements 268 are onboard within the PED.

Sensor 210, also known as sensor module, includes a visual element 272, audio 274, wearable element 276, and motion element 278. A function of sensor 210 is to detect information relating to optical sensing, audio detection, wearable reading, and PED's movement to predict or project user's current activity(s). Visual element or visual 272, in one example, detects surrounding visual images to identify current location of the PED. If, for example, visual element 272 detects a Starbuck® logo, visual element 272 reports a detection of a possible location. Alternatively, if the user is taking photos via PED camera, visual element 272 reports a photo shooting activity associated with the user.

Audio element or audio 274, in one embodiment, is able to detect and record surrounding sounds by an onboard microphone of the PED. For example, if audio element 274 detects music or opera sound, audio element 274 can indicate that the user is in a concert or a play. Alternatively, if audio element 274 detects that the user is talking via PED, audio element 274 may report that the user is on the phone. Audio element 274 can also report that the user is talking with others if it detects that the user is talking.

Wearable element 276 is able to obtain information accumulated by a wearable device such as Fitbit® wrist band or iWatch®. For example, if the user is running wearing a Fitbit®, the recording collected by Fitbit® is ported to wearable element 276 to verify user's current status. Alternatively, wearable element 276 can also communicate with other wearable and/or implanted devices such as a defibrillator.

Motion element 278, in one embodiment, detects current movement associated with the PED. For example, motion element 278 includes multiple sensors to detect movement of PED. The movement, such as walking, driving, running, and/or sitting, can be detected by motion element 278. To identify use's current status, my-status uses sensor 210 to obtain information relating to surrounding images, surrounding sounds, movements, and the like. Note that other elements such as element 279 may also be included in sensor 210.

After collecting information from location 206, calendar 208, and sensor 210 by collector 204, the information is passed onto status 202. Status 202 generates current status 220-222 associated with different selected groups of audiences. For example, if the current status indicates that is family time, the calls will not be blocked if the caller is a family member. Also, different groups of audience may notice different icon. For example, VIP group may see swimming icon while friends group may see busy icon.

Filter 212, which is coupled to status 202, provides a filtering function based on a predefined set of audience. In one embodiment, filter 212 stores filtered status in its database 216. It should be noted that Tx/Rx 214 broadcasts multiple current status to multiple selected groups of audience. Note that the predefined set of audience is a predefined set of contact list which is setup by the user. The predefined set of contact list may be stored in a memory 214 in the PED. After filtering, the current status is broadcasted via base station 112 and Internet 102.

An advantage of using my-status or my-status app is that it will provide user's current status to a set of predefined group of audience whereby an audience can decide whether to place call or not.

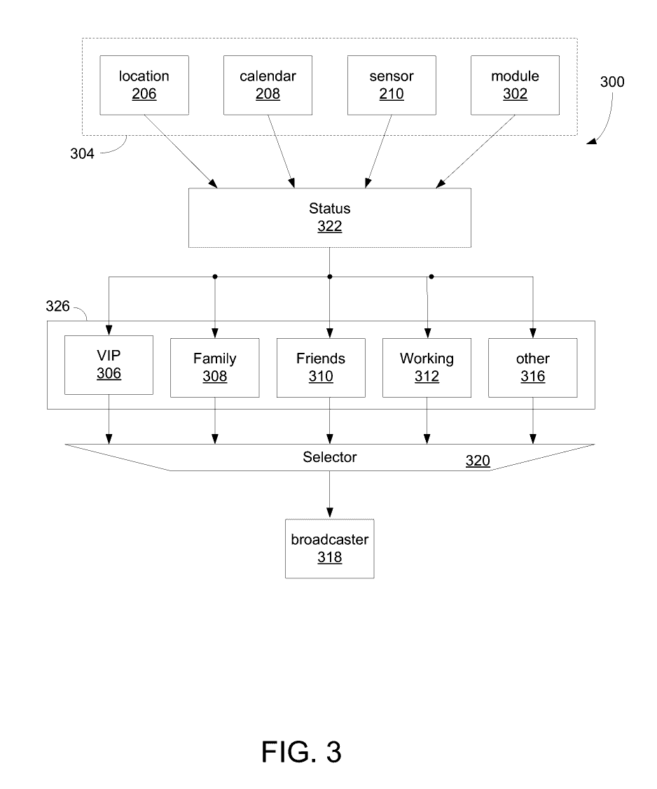

FIG. 3 is a block diagram 300 illustrating a my-status logic flow capable of generating and broadcasting current status in accordance with one embodiment of the present invention. Diagram 300 includes collector 304, status 322, filter 326, and broadcaster 318. Collector 304 further includes location 206, calendar 208, and sensor 210. Other modules such as modules 302 may be included in collector 304. For example, other module 302 can be a remotely connect device capable of providing current status based on predefined set of parameters. It should be noted that the underlying concept of the exemplary embodiment(s) of the present invention would not change if one or more blocks (or networks) were added to or removed from diagram 300.

Once the information is collected, status 322 is able to generate current status using the collected information. Filter 326, in one aspect, retrieves current status from status 322 and filters (or categorizes) recipients of current status based on the contact list. Filter 326, in one embodiment, includes multiple groups, such as VIP 306, family 308, friends 310, working 312, and other group 316. A function of filter 326 is to decide who are the audience or recipients for the status broadcasting.

In one example, the user of PED specifies who will be the person in VIP 306. For example, VIP 306 could include user's boss, business partners, bankers, and the like. While family 308 includes family members such as spouse, children, siblings, parents and the like, friends 310 includes friends, acquaintance, associates, and so forth. Working 312 includes colleagues, partners, associates, etc. Based on the selection or categorization made by the user of PED, selector 320 selects a group of audience and forwards to the audience list to broadcaster 318. Broadcaster 318 subsequently broadcasts the current status to a selected group of audience.

In one embodiment, PED, containing a digital processing unit, memory, transmitter, and receiver, is able to processing information via a communications network. The PED, in one embodiment, includes a location module, a calendar module, and a my-status collector, a status filter, and a transmitter. The location module is configured to collect a geographic location associated with the PED. The calendar module is able to obtain scheduled information associated with the EUE to track scheduled events listed in a calendar of the PED. In one example, my-status collector is configured to generate current status associated with the user of PED in accordance with the geographic location and the scheduled information. The status filter generates filtered status according to a predefined set of contact list. The transmitter is able to forward the filtered status to a selected audience via the communications network based on the predefined set of contact list. It should be noted that the contact list is stored in the PED.

The PED further includes a sensing module configured to include a visual component and an audio component. The sensing module obtains sensed information detected by a visual component. The sensing module, for example, uses an optical camera of the PED to collect visual information while uses a microphone of the PED to collect audio information. In addition to communicating with a global positioning system (“GPS”), the location module is also capable of scanning nearby wireless network to estimate current geographic location of the PED.

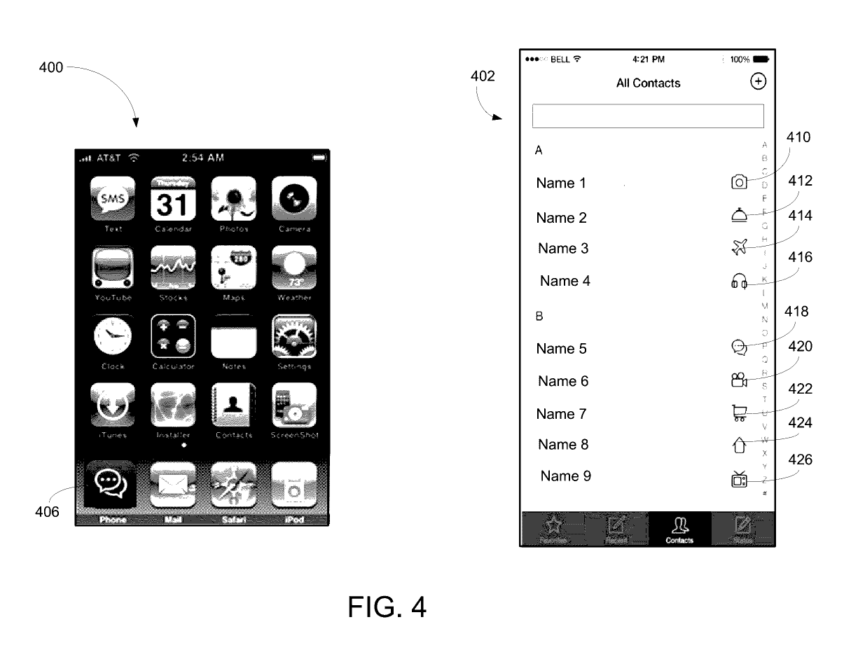

FIG. 4 illustrates exemplary images 400-402 displayable by a PED showing current status in accordance with one embodiment of the present invention. Diagram 400 illustrates a PED screen with a tile or icon interface layout. The PED screen shows a my-status tile 406. In one aspect, my-status tile or icon 406 can be tapped to activate or deactivate my-status application. It should be noted that the underlying concept of the exemplary embodiment(s) of the present invention would not change if one or more blocks (or networks) were added to or removed from diagram 400 or 402.

Diagram 402 illustrates a portion of a contact list showing current status icons 410-426. Icons 410-426 are representative icon symbols and they can be changed or updated by service providers or user(s). Any change or update of icon, however, does not alter the underlying concept of the present invention. For example, icon 410 indicates that name 1, a user of a PED, is currently taking photos. Icon 414 indicates that name 3, another PED user, is in flight. Icon 420 indicates that name 6 is watching a movie. Icon 418 indicates that my-status app for name 5 is disabled. It should be noted that the app can be operated under PED operating system (“OS”) with its embedded functions.

In an exemplary operation, “user A” goes to one of current smartphone(s) functions related to “current status” such as flight mode, on-call, on-meeting, et cetera, and selects the related desired status. For example if “a flight mode” is selected, it will update profile status, server update and other “friends”/“followers” update before the phone enters the offline mode. The “user B” subsequently sees the status of “User A” and act accordingly.

The update can be done either by “calendar” or “location” via GPS or by any wearable devices such as a watch or bracelet. In addition, the update may include integrated applications or devices and/or OS pre-set functions that will update your status and profile accordingly. For example, “User A” enables a GPS tracking and goes to a gym. The application detects the location of User A, and updates status and profile accordingly. Upon updating at the server, “user B” and other friends of User A can see the status of “user A” since the server has been updated.

The wearable device, in one example, usually detects user's mode. For example, if “User A” is sleeping and wearable is already connected to his phone via Bluetooth or other mechanism, profile will change to reflect “sleeping mode.” When the status changes, server will be updated where “user B” and other friends will see the status of “user A” accordingly.

An advantage of using my-status to provide current status via icons is that a caller can make an informed decision as to whether he or she should call the user. My-status should allow PED users to make better decisions as to when to make the call.

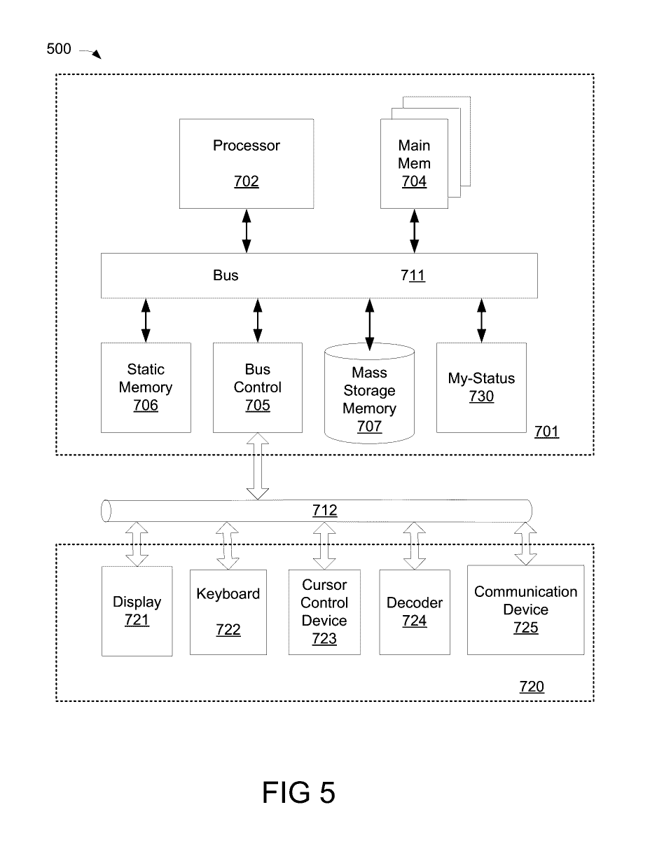

Having briefly described aspect of my-status able to provide current status to a selected group of audience, FIG. 5 is a block diagram illustrating an exemplary PED, transmission device or system capable of operating my-status or my-status app in accordance with one embodiment of the present invention. FIG. 5 illustrates an exemplary computing system 500 with feature of my-status may be implemented. It will be apparent to those of ordinary skill in the art that other alternative network or system architectures may also be employed.

Computer system 500, which can be applied to a PED, includes a processing unit 701, an interface bus 712, and an input/output (“IO”) unit 720. Processing unit 701 includes a processor 702, main memory 704, system bus 711, static memory device 706, bus control unit 705, and mass storage memory 707. Bus 711 is used to transmit information between various components and processor 702 for data processing. Processor 702 may be any of a wide variety of general-purpose processors, embedded processors, or microprocessors.

Main memory 704, which may include multiple levels of cache memories, stores frequently used data and instructions. Main memory 704 may be RAM (random access memory), MRAM (magnetic RAM), or flash memory. Static memory 706 may be a ROM (read-only memory), which is coupled to bus 711, for storing static information and/or instructions. Bus control unit 705 is coupled to buses 711-712 and controls which component, such as main memory 704 or processor 702, can use the bus. Mass storage memory 707 may be a magnetic disk, solid-state drive (“SSD”), optical disk, hard disk drive, floppy disk, CD-ROM, and/or flash memories for storing large amounts of data.

I/O unit 720, in one example, includes a display 721, keyboard 722, cursor control device 723, web browser 724, and communication device 725. Display device 721 may be a liquid crystal device, flat panel monitor, cathode ray tube (“CRT”), touch-screen display, or other suitable display device. Display 721 projects or displays graphical images or windows. Keyboard 722 can be a conventional alphanumeric input device for communicating information between computer system 700 and computer operator(s). Another type of user input device is cursor control device 723, such as a mouse, touch mouse, trackball, or other type of cursor for communicating information between system 700 and user(s).

Communication device 725 is coupled to bus 211 for accessing information from remote computers or servers through wide-area network. Communication device 725 may include a modem, a router, or a network interface device, or other similar devices that facilitate communication between computer 700 and the network. In one aspect, communication device 725 is configured to perform wireless functions.

My-status 730, in one aspect, is coupled to bus 711 within processing unit 701. In one example, my-status 730 is configured to provide current status using location, calendar, and sensor components. My-status 730 can be operated in hardware, software, firmware, or a combination of hardware, software, and firmware.

The exemplary aspect of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary aspect of the present invention. Alternatively, the steps of the exemplary embodiment of the present invention may be performed by specific hardware components that contain hard-wired logic for performing the steps, or by any combination of programmed computer components and custom hardware components.

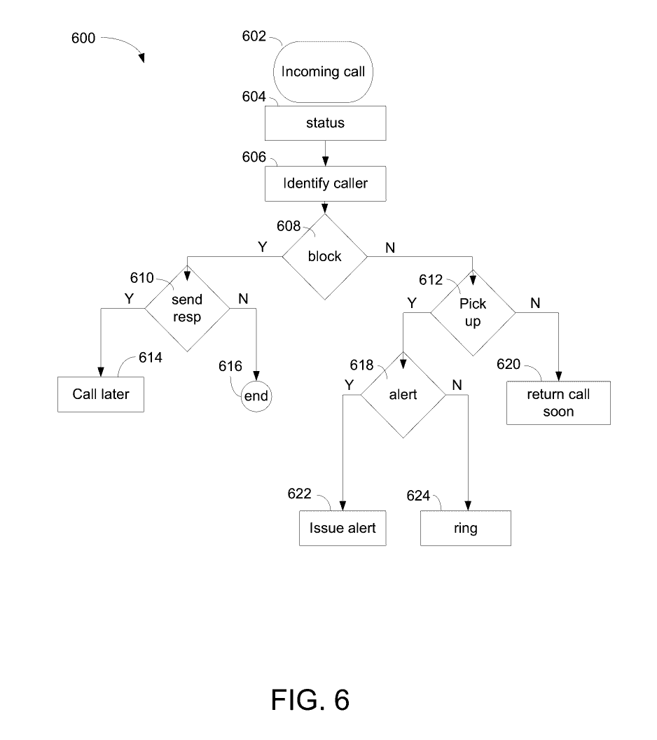

FIG. 6 is a flowchart 600 illustrating a process of receiving an incoming call using my-status in accordance with one embodiment of the present invention. Flowchart 600 illustrates an incoming call that is initiated and received by a cellular phone or PED which contains a digital processing unit, memory, transmitter, and receiver capable of transmitting and receiving information or data via a communications network. After broadcasting current status associated to the cellular phone or PED via an onboard my-status application through the communications network, the process, at block 602, receiving a connection request or incoming call from a requesting device through the communications network. In one example, the connection request is initiated by a mobile phone or another PED requesting a voice connection. Upon checking and verifying current status at block 604, the user of the requesting device, at block 606, is identified in accordance with a priority contact list stored in the memory. At block 608, the process exams whether to block the call or allow connection.

If the block is selected, the process proceeds to block 610 to exam whether a call-later response should be sent. If the call-later response is not necessary according to the contact list, the process ends at block 616. Otherwise, the call is blocked and a call-later response is sent at block 614.

At block 612, the process determines whether the incoming call should be pickup immediately or seek a response from the user before picking up the call. If the pickup is not identified, the process proceeds to block 620 to issue a return-call soon message to the caller. If the pickup is determined, the process overwrites the block-incoming communication status which is established in response to the priority of the user of the requesting device established by the my-status application. At block 618, the process exams whether an alert signal should be issued. If the alert signal is needed, a notification of incoming communication request is issued via the cellular phone. Otherwise, the process activates a ring tone signaling an incoming call at block 624.

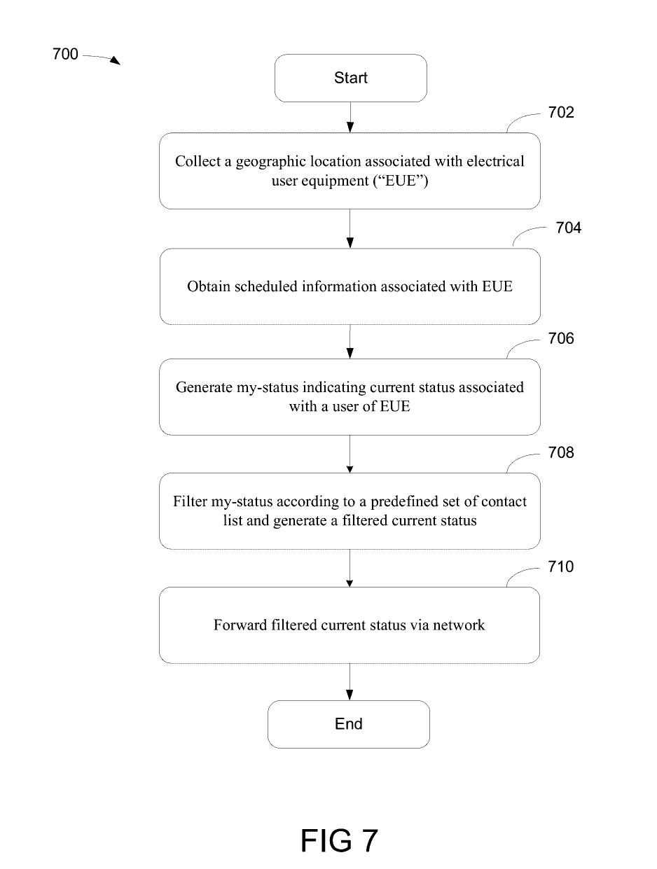

FIG. 7 is a flowchart 700 illustrating a process of providing current status using my-status in accordance with one embodiment of the present invention. At block 702, a process operated by a PED or EUE or cellular phone is capable of collecting a geographic location associated with the EUE. A location module which is onboard the EUE or PED able to indicate the current location of the EUE. For example, the location module can use GPS to locate current location of EUE. In one aspect, the process is also able to scan nearby broadcasting radio frequency to assess the current geographic location of EUE based on detected radio frequency. Also, a movement of the PED or EUE based on the GPS may be detected by the onboard motion detector.

At block 704, after obtaining scheduled information associated with the EUE from a calendar module, current status associated with a user of the EUE, at block 706, is generated in accordance with the geographic location and the scheduled information. Upon obtaining scheduled events from onboard electronic calendar of the EUE, scheduled events are collected by a computing device logically connected to the EUE. For example, a computing device can be remotely connected to the EUE. In addition, earlier planned itinerary can also be obtained and used for determining the current status of EUE.

At block 708, upon filtering current status according to a predefined set of contact list, the filtered current status, at block 710, is forwarded to a selected group of audience via the communications network based on the predefined set of contact list. In one embodiment, the process fetches sensing information from a sensing module indicating possible status associated with the user of the EUE. For example, after obtaining current location of the EUE from GPS, the current location of the EUE is tracked and verified from an onboard tracking component. In addition, upon obtaining wearable information via a nearby wearable device, the wearable information may be used to assess possible current status associated with the EUE. Also, driving information can be collected via an automobile to sense movement status of the EUE wherein the driving information can be used to identify possible current location of EUE.

While particular embodiments of the present invention have been shown and described, it will be obvious to those skilled in the art that, based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

1. A method operated by an electrical user equipment (“EUE”) containing a digital processing unit, memory, transmitter, and receiver capable of providing information via a communications network, comprising:
collecting a geographic location associated with the EUE from an onboard location module indicating current position of the EUE;
obtaining scheduled information associated with the EUE from a calendar module configured to track scheduled events listed in a calendar of the EUE;
generating current status associated with a user of the EUE in accordance with the geographic location and the scheduled information;
filtering current status according to a predefined set of contact list and generating a filtered current status; and
forwarding the filtered current status via the communications network based on the predefined set of contact list.

2. The method of claim 1, further comprising fetching sensing information from a sensor module detected by one or more onboard sensors on the EUE.

3. The method of claim 1, further comprising transmitting the filtered current status via an onboard transmitter via a wireless communications network.

4. The method of claim 1, wherein collecting a geographic location associated with the EUE includes,
obtaining current location of the EUE from a global positioning system (“GPS”); and
tracking and verifying the current location of the EUE utilizing an onboard tracking component.

5. The method of claim 4, wherein collecting a geographic location associated with the EUE includes scanning nearby broadcasting radio frequency to assess current geographic location based on detected radio frequency.

6. The method of claim 5, wherein collecting a geographic location associated with the EUE further includes monitoring movement of the EUE based on the GPS and onboard motion detector.

7. The method of claim 1, wherein obtaining scheduled information associated with the EUE includes,
retrieving scheduled events from onboard electronic calendar of the EUE; and
collecting scheduled events from a computing device logically connected to the EUE.

8. The method of claim 7, wherein obtaining scheduled information associated with the EUE includes obtaining itinerary transactions recorded in event log.

9. The method of claim 1, wherein generating current status associated with a user of the EUE includes generating one of available status, busy status, in-a-meeting status, at-school status, at-work status, and sleeping status.

10. The method of claim 2, wherein fetching sensing information from a sensor module includes,
obtaining visual information via onboard optical sensing component to identify current status of the EUE; and
collecting audio information via onboard audio sensing component to identify current status of the EUE.

11. The method of claim 10, wherein fetching sensing information from a sensor module includes,
obtaining wearable information via a nearby wearable device for identifying current status of the EUE; and
collecting driving information via an automobile to sense moving status of the EUE.

12. The method of claim 1, further comprising issuing an alert signal to the user of the EUE in response to an incoming call received by an onboard receiver of the EUE.

13. A portable electronic device (“PED”) containing a digital processing unit, memory, transmitter, and receiver able to processing information via a communications network, comprising:
a location module configured to collect a geographic location associated with the PED indicating current location of the PED;
a calendar module coupled to the location module and able to obtain scheduled information associated with the EUE for assessing current status of a user of the PED;
a collector coupled to the location module and configured to generate current status associated with the user of the PED in accordance with the geographic location and the scheduled information;
a filter coupled to the collector and capable of generating a plurality of filtered status according to a predefined set of audience list; and
a transmitter coupled to the status filter and able to broadcast the filtered status via the communications network based on the predefined set of audience list.

14. The device of claim 13, further comprising a sensor module coupled to the collector and configured to include a visual component and an audio component, wherein the sensor module obtains optical images sensed by the visual component.

15. The device of claim 14,
wherein the sensor module is coupled to an optical camera of the PED and able to collect visual information; and
wherein the sensor module is coupled to a microphone of the PED to collect audio information.

16. The device of claim 13, wherein the location module is coupled to a global positioning system (“GPS”) to obtain current location of the PED.

17. The device of claim 13, wherein the location module scans nearby wireless network to estimate current geographic location of the PED.

18-20. (canceled)

21. A method operated by a smart phone, comprising:
identifying a physical location associated with the smart phone from an onboard location module indicating current physical location associated with the smart phone;
searching a predefined schedule relating to the smart phone by a scheduler which contains information for tracking scheduled events;
generating current status associated with a user of the smart phone in accordance with the physical location and the predefined schedule; and
forwarding the current status to a group of subscribers based on a predefined set of contact list via a communications network.

22. The method of claim 21, further comprising fetching sensing information from a sensor module detected by one or more onboard sensors on the smart phone.

23. The method of claim 21, further comprising transmitting the current status via an onboard transmitter via a wireless communications network.
